(19) United States
(12) Patent Application Publication
(10) Pub. No.: US 2009/0228293 A1
(43) Pub. Date: Sep. 10, 2009

(54) MINIMUM CORRELATION DESIGN OF EXPERIMENT RUN ORDER

(75) Inventor: Jeffrey M. Fowler, Rochester, NY (US)

Correspondence Address: Gibb Intellectual Property Law Firm, LLC, 2568-A Riva Road Suite 304, Annapolis, MD, 21401, US

(73) Assignee: XEROX CORPORATION, Norwalk, CT (US)

(21) Appl. No.: 12/045,056

(22) Filed: Mar. 10, 2008

(51) Int. Cl. G06Q 10/00

(52) U.S. Cl. 705/1

(57) ABSTRACT

A method provides an experiment plan that produces experimental results based on input variables. The method creates a cost function for runs of the experiment plan. The cost function considers an order in which the runs occur. The method also optimizes the cost function to minimize costs between the runs of the experiment plan and the order in which the runs occur to produce an optimized run order. This optimized run order is output.

### BACKGROUND AND SUMMARY

Embodiments herein generally relate to design of experiments type of experiment planning and more particularly to systems and methods that optimize a cost function to minimize the costs between the order in which runs occur and the factors (independent variables).

As described in U.S. Pat. No. 7,092,863 (the complete disclosure of which is incorporated herein by reference) automatic process control as a means of controlling the conditions under which a process is carried out is well known. Similarly, U.S. Patent Publication 2006/0259158 (the complete disclosure of which is incorporated herein by reference) discloses a system for automating scientific and engineering experimentation.

Further, U.S. Patent Publication 2004/0143834 (the complete disclosure of which is incorporated herein by reference) explains that when designing a scientific experiment, the user can use an automated experiment plan program. The user can decide which tasks should be selected for use by dragging and dropping them into place in a procedure builder. This allows a design of experiments (DOE) engine to instantiate an experiment object followed by successive run objects.

Each run object can have variations introduced which make each run similar to the original procedure but not exactly the same. By completing these run objects the researcher hopes to see how the variations which were introduced affect the final output or result of the experiment.

A resource library allows users to create resource objects for addition to the library. Resources can either be equipment or materials. A resource must be created before it can be used in a task. Resources in turn contain parameters. In the case of equipment resources which are programmable, the system can capture each step and parameter involved in the program. When a resource is created its parameters can be given specific values (configurations).

Users can create tasks which can use one or more resources in the library. These resources are grouped together under the task and instructions are added in how to carry out the task. When selecting a resource for a task, a specific configuration can also be selected or a new one created. A SOP (standard operating procedure) library contains standard operating procedures which can be re-used in the system as procedures.

The DOE engine converts procedures to run objects. The DOE engine allows the researcher to select what they wish to vary and then produces resultant runs of the experiment, each run being a different substantiation of the original procedure. The tool implements a number of processes which are configured to minimize the number of run objects that are required, given a fixed number of factors which are to be varied. The user first specifies which procedure is to be used as an input to the DOE engine. The user then specifies which DOE process he wishes to use to generate the experiment.

A common prediction method is known as Design of Experiments (DOE). One commercially available DOE application is known as DOE Pro® and is available from Six Sigma Products Group, Inc., located in Colorado Springs, Colo., USA. Runs of said experiment plan in DOE products such as DOE Pro® could be run in a randomized order. For example, the DOE Pro® software includes a random order in which runs occur as a feature. However, this approach does not address a significant risk of aliasing between the order in which runs occur and the factors.

Therefore, with embodiments herein the order in which the runs occur is optimized to minimize the correlation between the order in which runs occur and the factors. The optimization process comprises minimizing the cost function over the set of all possible orders subject to some set of constraints. Any appropriate cost function involving correlation among the order in which the runs occur, factors, and factor interactions may be considered, and any appropriate optimization algorithm may be applied. The embodiments herein can use any cost function, such as the sum of the squared correlations between the order in which runs occur and each factor as the cost function, and a random search as the optimization algorithm. Candidate order in which runs occurs may be constrained to a subset of all possible orders, for instance by requiring that some factors not be re-ordered.

In addition, the embodiments herein cover cost functions that do not incorporate the statistical correlation function, but rather a more general class of cost functions that relate to the motivations: reduce sensitivity of analysis estimates to noise, increase the sensitivity of analysis statistics to exogenous noise, and any other ways in which exogenous noise affects the quality of the analysis. Therefore, the word “correlation” is used in the non-technical sense herein.

For example, in one embodiment a method first creates an experiment plan that will produce experimental results based on input variables. The method creates a cost function that considers the order in which the runs occur. The experimental results are expected to change when values of the input variables change.

Then, the method analyzes the cost function with respect to the order in which the runs of the experiment plan are performed to identify correlations between the run results and the order in which the runs occur. Thus, the embodiments herein optimize the cost function to minimize the correlation between the runs of the experiment plan and the order in which the runs occur. This optimized order in which the runs occur can then be output.

The optimization process comprises minimizing a cost function associated with a correlation between the run results. If there is no correlation between the runs of the experiment plan and the order in which the runs occur, then the correlation between runs of the experiment plan and the order in which the runs occur is minimized.

The embodiments herein are not limited to methods, but also include system and computer program embodiments. For example, a system embodiment includes an experiment design module that creates the experiment plan. A cost function module is operatively connected to the experiment design module and creates a cost function for runs of the experiment plan. The cost function considers the order in which the runs occur. An optimizer is operatively connected to the cost function module, wherein the optimizer performs a process that optimizes the cost function to minimize correlation between the runs of the experiment plan and the order in which the runs occur to produce an optimized run order. In addition such as system includes an interface (operatively connected to the optimizer) that outputs the optimized order in which the runs occur.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating embodiments herein;

FIG. 2 is a schematic diagram illustrating one system embodiments herein; and

FIG. 3 is a schematic diagram illustrating different evaluations of the cost function J.

### DETAILED DESCRIPTION

As mentioned above, runs of an experiment plan could be run in a randomized order. The purposes of randomization are the same as the purposes of optimization. However, randomization does not address a significant risk of aliasing between the order in which the runs occur and the factors. Therefore, with embodiments herein the order in which runs occur is optimized to minimize the correlation between the order in which runs occur and the factors (independent variables).

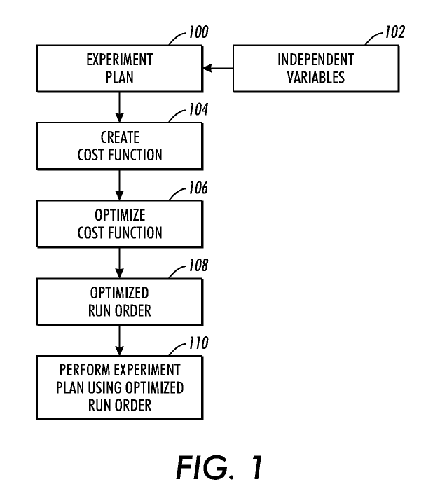

More specifically, as shown in flowchart form in FIG. 1, one method embodiment provides an experiment plan 100 that produces experimental results based on input independent variables (factors) 102. The experimental results are expected to change when values of the independent variables 102 change.

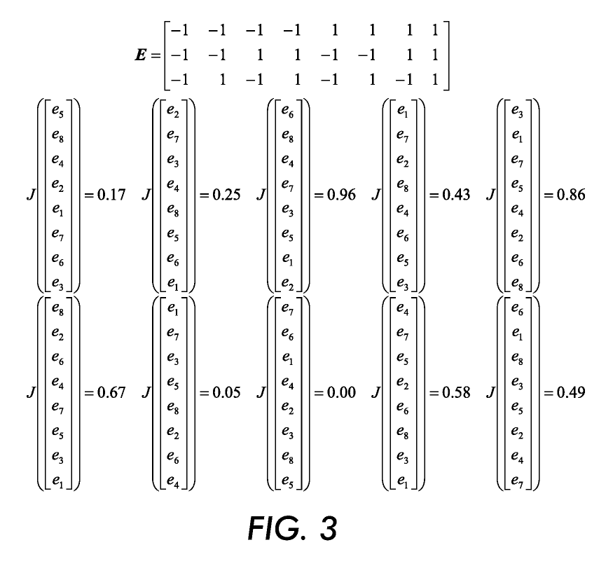

The method creates a cost function in item 104. The cost function considers the order in which the runs occur. The cost function is created so as to minimize the expected impact of exogenous noises on the estimates resulting from the data analysis. The conceptual steps are these: 1. Characterize the controlled inputs to the analysis (this is the factors A, B, C . . . and some, all, or none of their interactions AB, AC, BC . . . or other terms such as quadratics AA, BB, CC . . . ); 2. Hypothesize the disturbance (with embodiments herein the hypothesized disturbance is a linear function of the run number); and 3. Construct a cost function which increases as the expected deviation of the estimates from the true values. The correlation-based cost function shown in FIG. 3 is one structure that represents that sensitivity with a minimum of a priori assumptions and modest computational requirements.

In general, the cost function can be generated automatically. One implementation builds a cost function of the form given in FIG. 3 based on the set of coefficients to be estimated in the regression. The terms to be included are determined either based on the DOE format of the test plan, or by querying the user. The factors used in creating the cost function are exactly those that will be involved in the analysis.

Then, the method analyzes the cost function with respect to the order in which the runs occur to identify correlations between the runs and the order in which the runs occur. Thus, the embodiments herein can optimize the order in which the runs occur 108 to minimize the correlation between the runs of the experiment plan and the order in which the runs occur. This produces an optimized order in which the runs occur 108. This optimized order can then be output, as shown in item 108, and used to actually (physically) perform the experiment in item 110.

The optimization process 108 comprises minimizing the cost function. If there is no correlation between the runs of the experiment plan and the order in which the runs occur, then the correlation between runs of the experiment plan and the order in which the runs occur is minimized. Further, the candidate order in which the runs occur may be constrained to a subset of all possible orders, for instance by requiring that some factors not be re-ordered.

The optimization process 108 comprises minimizing the cost function over a set of admissible orders. The set of admissible orders may not include all permutations of runs, according to practical considerations, for instance excluding those permutations which would re-order certain factors. In other words, the optimization process 108 comprises minimizing the cost function over the set of all possible orders subject to some set of constraints. The set of constraints may be empty or may represent practical considerations, for instance by requiring that some factors not be re-ordered.

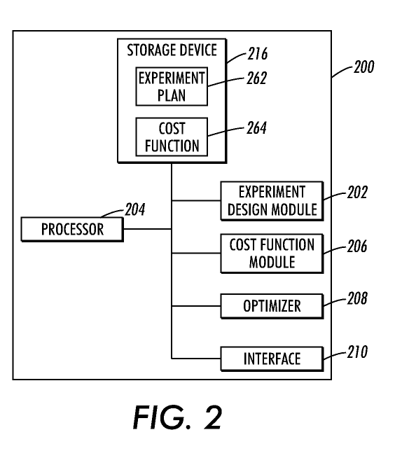

The embodiments herein are not limited to methods, but also include system and computer program embodiments. For example, as shown in FIG. 2, a system embodiment 200 includes an experiment design module 202 that is used to create the experiment plan 262. The experiment design module could be a DOE engine. The experiment plan 262 can be stored in a computer useable data carrier 216, such as a magnetic, or electronic computer storage device. A processor 204 (that is operatively connected to all other devices, and which interconnects all other devices) performs any processing that is necessary as directed by the remaining elements.

The system embodiment 200 also includes a cost function module 206 (that is operatively connected to the experiment design module 202) that creates a cost function 264 for runs of the experiment plan. The cost function 264 considers the order in which the runs occur. An optimizer 208 is operatively connected to the cost function module 206. The optimizer performs a process that optimizes the cost function to minimize correlation between the runs of the experiment plan and the order in which the runs occur to produce an optimized run order.

An interface 210 is also included (operatively connected to the processor 204) that outputs the optimized order in which the runs occur. The interface 210 can be of any kind, including a graphic user interface, a data interface, a network connection, a printer, etc.

Many computerized devices are discussed above. Computerized devices that include chip-based central processing units (CPU's), input/output devices (including graphic user interfaces (GUI), memories, comparators, processors, etc. are well-known and readily available devices produced by manufactures such as International Business Machines Corporation, Armonk N.Y., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein.

In one example shown in FIG. 3, one assumption made is that the order in which the runs occur is strongly correlated to slowly varying external noises or aging. Given a test plan matrix E of k factors and n runs, where Eᵢⱼ is the setting of factor i on run j, minimize the cost function

$$J ( R ) = {\sum }_{i = 1}^{k} {[ corr ( {e}_{i} ER , c ) ]}^{2}$$

where eᵢ are the row vectors with eᵢⱼ=δᵢⱼ, and c is the vector with cᵢ=i, over permutation matrices R.

In FIG. 3, there are n! candidate solutions, so a brute force search becomes unwieldy beyond n=7 or 8. The distribution of J is approximately exponential. One could elect to randomly choose 1000 candidate values for R and select the one with the smallest value for J(R). FIG. 3 presents a few candidate permutations for n=8.

In FIG. 3, the optimal permutation matrix represents doing run 1 seventh, run 2 sixth, run 3 first, and so on, for an order in which the runs occur of 3, 5, 6, 4, 8, 2, 1, 7. This is not a unique solution; for example reversing the order would preserve the zero correlation.

Note that for some test plans a perfect 0 correlation is impossible. For example, a 2² full factorial DOE permits no value of J less than 0.2. For given values of k and n, smaller values of J mean generally that each factor is less correlated to order in which the runs occur, and thus less correlated to time, age, or slowly varying external noises.

Therefore, as shown above, the embodiments herein break away from the conventional wisdom, which teaches that runs should be performed randomly. Instead, with embodiments herein the order in which runs occur is critically analyzed using the cost function to reduce or eliminate any correlation between the order in which the runs occur and the results. Therefore, rather than performing runs randomly as is done conventionally, the embodiments herein perform the runs in an optimized order that minimizes correlation. This can be performed in very simple experiments as well as very complex modeling applications.

Thus, with embodiments herein the order in which the runs occur is optimized to minimize the correlation between run order and the factors. Any appropriate cost function involving correlation among run order, factors, and factor interactions may be considered, and any appropriate optimization algorithm may be applied. Further, the candidate run order may be constrained to a subset of all possible orders, for instance by requiring that some factors not be re-ordered. Also, the embodiments herein are applicable to any design experiment, and minimize the risk of misinterpretation of experimental results due to time, aging, or other slowly-varying external noise factors. For example, within the electrostatic or xerographic printing environments, the embodiments herein can be applied to a DOE studying the charge corotron for electrostatic printing devices and to a DOE studying the developer housing for electrostatic printing devices.

Further, the concept of design of experiments includes the design of all information-gathering exercises where variation is present, whether under the full control of the experimenter or not. (The latter situation is usually called an observational study.) Often the experimenter is interested in the effect of some process or intervention (the ‘treatment’) on some objects (the ‘experimental units’), which may be people. Design of experiments is thus a discipline that has very broad application across all the natural and social sciences. Therefore, the embodiments herein are broadly applicable to many fields of study.

All foregoing embodiments are specifically applicable to electrostatographic and/or xerographic machines and/or processes as well as to software programs stored on the electronic memory (computer usable data carrier 216) and to services whereby the foregoing methods are provided to others for a service fee. It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof.

1. A computer-implemented method comprising:
using a computer, creating an experiment plan that produces experimental results based on input variables;
using said computer, creating a cost function that characterizes said input variables and predicts disturbances for runs of said experiment plan, wherein said cost function considers an order in which said runs occur;
using said computer, optimizing said cost function to minimize costs between said runs of said experiment plan and said order in which said runs occur to produce an optimized run order; and
using said computer, executing said experimental plan in optimized run order.

2. The method according to claim 1, wherein said optimizing comprises evaluating said cost function to minimize a sum of squares of correlations between run number and input variable value.

3. The method according to claim 1, wherein said optimizing comprises minimizing said cost function over the set of all possible orders, subject to a set of constraints.

4. The method according to claim 1, wherein if there is no correlation between said runs of said experiment plan and said order in which said runs occur, then said costs between said runs of said experiment plan and said order in which said runs occur is minimized.

5. The method according to claim 1, wherein said experimental results are expected to change when values of said input variables change.

6. A computer-implemented method comprising:
using a computer, creating an experiment plan that produces experimental results based on input variables;
using said computer, creating a cost function that characterizes said input variables and predicts disturbances for runs of said experiment plan, wherein said cost function considers an order in which said runs occur;
using said computer, optimizing said cost function to minimize costs between said runs of said experiment plan and said order in which said runs occur to produce an optimized run order;
using said computer, outputting said optimized run order; and
using said computer, executing said experiment plan in said optimized run order to physically conduct said experiment plan and produce said experimental results.

7. The method according to claim 6, wherein said optimizing comprises evaluating said cost function to minimize a sum of squares of correlations between run number and input variable value.

8. The method according to claim 6, wherein said optimizing comprises minimizing said cost function over the set of all possible orders, subject to a set of constraints.

9. The method according to claim 6, wherein if there is no correlation between said runs of said experiment plan and said order in which said runs occur, then said costs between said runs of said experiment plan and said order in which said runs occur is minimized.

10. The method according to claim 6, wherein said experimental results are expected to change when values of said input variables change.

11. A system comprising:
an experiment design module used to create an experiment plan that produces experimental results based on input variables;
a cost function module operatively connected to said experiment design module, wherein said cost function module creates a cost function that characterizes said input variables and predicts disturbances for runs of said experiment plan, wherein said cost function considers an order in which said runs occur;
an optimizer operatively connected to said cost function module, wherein said optimizer performs a process that optimizes said cost function to minimize costs between said runs of said experiment plan and said order in which said runs occur to produce an optimized run order; and
an interface operatively connected to said optimizer, wherein said interface outputs said optimized run order.

12. The system according to claim 11, wherein said optimizer evaluates said cost function to minimize a sum of squares of correlations between run number and input variable value.

13. The system according to claim 11, wherein said optimizer minimizes said cost function over said set of all possible orders, subject to a set of constraints.

14. The system according to claim 11, wherein if there is no correlation between said runs of said experiment plan and said order in which said runs occur, then said costs between said runs of said experiment plan and said order in which said runs occur is minimized.

15. The system according to claim 11, wherein said experimental results are expected to change when values of said input variables change.

16. A computer program product comprising:
a computer-usable data carrier storing instructions that, when executed by a computer, cause the computer to perform a method comprising:
creating an experiment plan that produces experimental results based on input variables;
creating a cost function that characterizes said input variables and predicts disturbances for runs of said experiment plan, wherein said cost function considers an order in which said runs occur;
optimizing said cost function to minimize costs between said runs of said experiment plan and said order in which said runs occur to produce an optimized run order; and
executing said experimental plan in optimized run order.

17. The computer program product according to claim 16, wherein said optimizing comprises evaluating said cost function to minimize a sum of squares of correlations between run number and input variable value.

18. The computer program product according to claim 16, wherein said optimizing comprises minimizing said cost function over the set of all possible orders, subject to a set of constraints.

19. The computer program product according to claim 16, wherein if there is no correlation between said runs of said experiment plan and said order in which said runs occur, then said costs between said runs of said experiment plan and said order in which said runs occur is minimized.

20. The computer program product according to claim 16, wherein said experimental results are expected to change when values of said input variables change.
